(19) United States
(12) Patent Application Publication
(10) Pub. No.: US 2017/0316034 A1
(43) Pub. Date: Nov. 2, 2017

(54) INFORMATION PUBLISHING METHOD AND APPARATUS

(71) Applicant: Alibaba Group Holding Limited, Grand Cayman (KY)

(72) Inventors: Xiao Chen, Zhejiang (CN); Meng Zhang, Zhejiang (CN)

(21) Appl. No.: 15/653,425

(22) Filed: Jul. 18, 2017

Related U.S. Application Data
(63) Continuation of application No. PCT/CN2016/071163, filed on Jan. 18, 2016.

(30) Foreign Application Priority Data
Jan. 23, 2015 (CN) 201510035601.0

(51) Int. Cl. G06F 17/30; G06Q 30/06

(52) U.S. Cl. CPC G06F 17/30268; G06Q 30/0621; G06Q 30/0643

(57) ABSTRACT

A method and an apparatus of publishing information are disclosed. The method includes receiving input information of a user; extracting one or more keywords from the input information of the user; performing a search based on the one or more keywords, to obtain at least two data objects, each data object including at least one picture; extracting at least partial images from respective pictures of the at least two data objects; generating a combined image according to the at least partial images that are extracted; and sending the combined image to the user. Using the technical solution provided by the present application, published information is no longer information of a single data object, but a combination of information of multiple data objects, such that a display effect after information publishing is better.

### CROSS REFERENCE TO RELATED PATENT APPLICATIONS

This application claims priority to and is a continuation of PCT Patent Application No. PCT/CN2016/071163 filed on 18 Jan. 2016, and is related to and claims priority to Chinese Patent Application No. 201510035601.0, filed on 23 Jan. 2015, entitled “Information Publishing Method and Apparatus,” which is hereby incorporated by reference in its entirety.

### TECHNICAL FIELD

The present application relates to the field of Internet technologies, and in particular, to methods and apparatuses for publishing information.

### BACKGROUND

When a merchant publishes information nowadays, a server sends an image of a single data object to be published to a client terminal and displays the image on a front-end page. Only information of the single data object published by the merchant is displayed to a user on the front-end page after publishing, and the information displayed after publishing in this manner of publishing is less diversified and has poor display effects.

Deficiencies of existing technologies include displaying only information of a single data object after information publishing, which delivers poor display effects.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present application provide a method and an apparatus of publishing information, to solve the problem of poor display effects due to displaying only information of a single data object after information publishing in the existing technologies.

In implementations, the present application provides an information publishing method, The method may include receiving input information of a user; extracting one or more keywords from the input information of the user; searching to obtain at least two data objects based on the one or more keywords, each data object including at least one picture; extracting at least portions of images from respective pictures of the at least two data objects; generating a combined image based on the at least extracted portions of the images; and sending the combined image to the user.

In implementations, the present application provides an information publishing apparatus. The apparatus may include a receiving module configured to receive input information of a user; a data object search module configured to extract one or more keywords from the input information of the user, and search to obtain at least two data objects based on the one or more keywords, each data object including at least one picture; a generation module configured to extract at least portions of images from respective pictures of the at least two data objects, and generate a combined image based on the at least extracted portions of the images; and a sending module configured to send the combined image to the user.

Beneficial effects include the following:

In the embodiments of the present application, input information of a user is received and one or more keywords are extracted from the input information first. Searching is performed based on the one or more keywords to obtain at least two data objects, with each data object including at least one picture. At least portions of images are extracted from respective pictures of the at least two data objects, and a combined image is generated based on the at least extracted portions of the images. The combined image is finally sent to the user. In this way, when information is published, the published information is no longer information of a single data object, but a combination of information of multiple data objects. Thus, a combined image of multiple data objects is provided to the user. A better display effect is achieved after this manner of information publishing is employed for publishing.

### BRIEF DESCRIPTION OF THE DRAWINGS

Exemplary embodiments of the present application will be described hereinafter with reference to accompanying drawings.

FIG. 1 shows a schematic flowchart of an implementation of an information publishing method according to an embodiment of the present application.

FIG. 2 shows a schematic diagram before and after information publishing according to an embodiment of the present application.

FIG. 3 shows a schematic structural diagram of an information publishing apparatus according to an embodiment of the present application.

### DETAILED DESCRIPTION

Exemplary embodiments of the present application are described in further detail hereinafter with reference to the accompanying drawings to further clarify technical solutions and advantages of the present application. Apparently, the described embodiments represent only a part and not all of the embodiments of the present application. Moreover, the embodiments in the present specification and features in the embodiments may be mutually combined without any conflict.

To solve the deficiencies in the existing technologies, the embodiments of the present application provide a method and an apparatus of publishing information, which are described in the following.

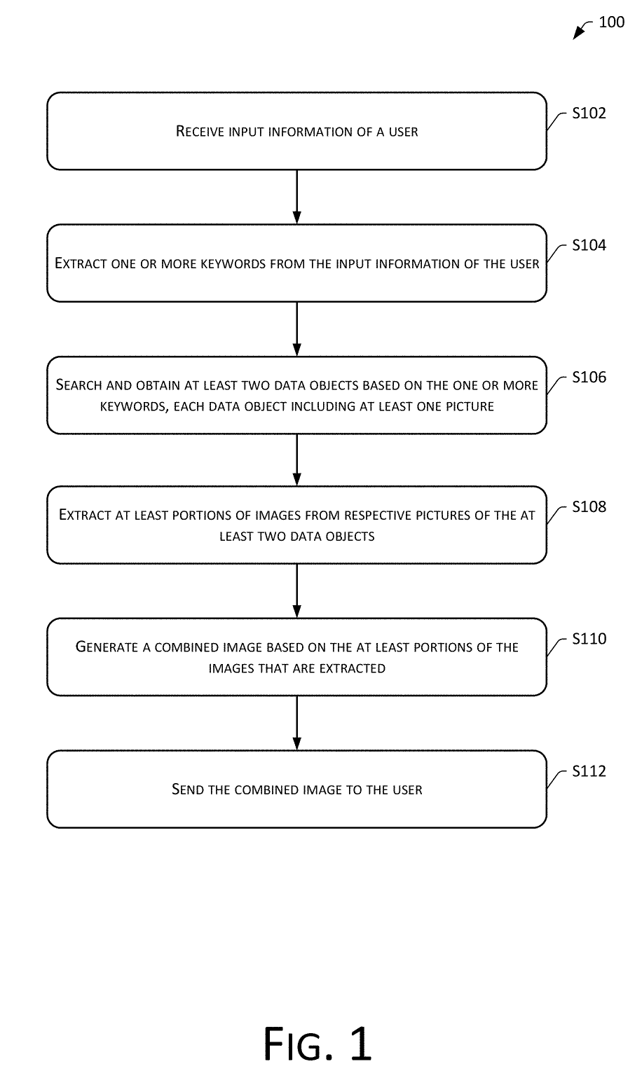

FIG. 1 shows a schematic flowchart illustrating an example information publishing method 100 according to an embodiment of the present application. As shown in the figure, the information publishing method 100 may include the following method blocks.

S102 receives input information of a user.

S104 extracts one or more keywords from the input information of the user.

S106 searches and obtains at least two data objects based on the one or more keywords, each data object including at least one picture.

S108 extracts at least portions of images from respective pictures of the at least two data objects.

S110 generates a combined image based on the at least portions of the images that are extracted.

S112 sends the combined image to the user.

Publishing a clothing combination is used as an example. Keywords may be style keywords such as a “Korean-style” and a “Japanese-style”, etc., and may alternatively be a keyword such as an “European-style furniture”, for example. Searching is performed according to one or more keywords to obtain at least two data objects. Specifically, at least two articles, such as two pieces of Korean-style clothes, or a piece of Korean-style clothes and a Korean-style necklace, etc., may be determined according to the style keywords such as “Korean-style” and “Japanese-style”, for example. These articles each include a display picture of at least one article, which may be a front picture, a back picture, etc.

An existing keyword extraction technology may be employed to extract one or more keywords from the input information of the user. Searching and obtaining the at least two data objects according to the one or more keywords may include establishing a weight model using these keywords as an input set and performing a semantic search thereon to obtain at least two data objects. The existing technologies may be employed for specific implementation. The present application does not impose any limitation on a specific method of extracting a keyword, a method of searching for a data object according to the keyword, and the like.

In implementations, at least partial images are extracted from respective pictures of the at least two data objects. Primary images may be cut out from the pictures of the data objects using a cutout algorithm such as Bayes, and image feature values, such as color, texture, and shape, are extracted from the primary images, for performing operations such as analysis and high-order index creation. In addition, image processing such as deepening and color modulation may be performed on the extracted portions of the images. Specific procedures of all these image processing operations may employ the existing image processing technologies, and are not described in detail herein.

The combined image may further include other information such as a respective picture path of the picture of each data object.

The exemplary information publishing method extracts one or more keywords according to input information of a user upon receiving the input information of the user, performs a search according to the keywords to obtain at least two data objects with each data object including at least one picture, extracts at least partial images from respective pictures, and generates a combined image based on the partial images, which is then sent to the user. As such, a combined image including pictures of multiple data objects is provided to the user. Therefore, published information is no longer information of a single data object only, but a combination of information of multiple data objects.

In implementations, the combined image may further include link information of each data object.

Publishing a clothing combination is continued to be used as an example. Link information of each data object may be a Uniform Resource Locator (URL) address of a detail page of a respective article, such as a URL address of a detail page of a trench coat.

A position of the link information of each data object may be set at a position of a portion of image associated with the respective data object in the combined image. When the user clicks that portion of image associated with the data object, the link information of the data object may be accessed automatically. For example, a URL address of a detail page of a trench coat may be located at the same position of an image of the trench coat. As such, the detail page of the trench coat may be automatically jumped to, when the user clicks the image of the trench coat.

In implementations, the above positioning may be implemented using map and area attributes of an img label in the existing technologies. Details of an implementation may include the following:

<imgsrc=“graphic file name” usemap=“#picture name”>
<mapname=“picture name”>
<areashape=shape coords=area coordinate list href=“URL address”>
...
<areashape=shape coords=area coordinate list href=“URL address”>
</map>

The above code is an implementation of positioning a URL address using map and area attributes in an img label. One skilled in the art may also implement positioning in other manners, which are not limited in the present application.

In implementations, operations such as the above positioning may not be performed, and the combined image including the link information of each data object is directly sent to the user. In this case, an effect manifested to the user may include separately displaying the link information of the data object and the portion of image associated with the data object. For example, link information of a trench coat and link information of a scarf may be displayed below images of the trench coat and the scarf, etc. Although the display effect of this type of combined image is not as good as the display effect after using positioning, these two methods can be employed in specific uses, and one skilled in the art can select one according to an actual requirement.

By including link information of each data object in a combined image, the embodiment of the present application enables a user to further access the link information of the respective data object when the user views the combined image, which is convenient and efficient, thus further improving user experience.

To avoid a problem that the display effect fails to meet an actual requirement of a user due to data objects in a combined image both coming from a same category (e.g., a combination of a trench coat and a trench coat), the embodiment of the present application can further be implemented in the following manner.

In implementations, the data objects may be obtained by performing searches under different categories.

For example, searching may be performed in different categories such as clothing, accessories, shoes, and bags according to a keyword “Korean-style”, to obtain at least two articles such as Korean-style clothes, accessories, shoes or bags. As such, a combined image that is generated includes articles under multiple categories, instead of articles under a same category.

The embodiment of the present application performs searching in different categories according to a keyword to obtain at least two data objects, and finally combines portions of respective images associated with the data objects of different categories, such that a combined image is closer to a matching requirement of a user. The combined image of the data objects of the different categories is provided to the user, thus further improving display effects brought by the combined image.

In an implementation, after obtaining the at least two data objects by performing the search based on the one or more keywords, the information publishing method may further include determining an identifier of each data object. The combined image may further include the identifier of each data object.

An identifier of each data object may be keyword(s) that is/are generated according to an existing algorithm or certain rule(s). For example, an article of “Dior perfume J∝Adore series” is used as an example. An identifier of the article may include keywords such as “Dior perfume” or “J'Adore series”, etc. The present application does not impose any limitation on an identifier of each data object and a specific manner of generating the identifier.

In implementations, the identifier of each data object may be labeled at a position of a portion of image associated with the respective data object in the combined image.

Labeling the identifier of each data object at the position of the portion of image associated with the respective data object in the combined image is not limited to a situation that the identifier of the data object and the image of the data object have identical coordinate positions. In an implementation, to prevent an identifier of an article from blocking an image part of the article, the identifier of the article may also be labeled at a position such as an upper left corner or a lower right corner of the image of the article. For example, an identifier similar to “a thermo cup” is labeled at an upper left corner of an image of a cup in a combined image, for identifying and illustrating the cup, to facilitate a user to view and understand the meaning represented by the image of the cup, etc.

In implementations, the identifier of each data object may be labeled as a page element at a corresponding position of the respective portion of image of the data object using an absolute positioning method of Cascading Style Sheets (CSS). Other methods may also be used for labeling, and a specific labeling method is not limited in the present application.

In the embodiments of the present application, after searching is performed according to one or more keywords to obtain at least two data objects, an identifier of each data object may be further determined, and the identifier is included in a combined image that is generated, to identify and describe the respective data object. As such, a user can further know the data object from the identifier such as text, in addition to viewing the combined image.

In implementations, generating the combined image based on the at least extracted portions of images may specifically include combining a respective portion of image associated with each data object according to different sizes and/or positions to generate a combined image of a designated size.

In implementations, the designated size may be determined according to a size of an advertising space of the article on an article display page.

In the embodiments of the present application, portions of images of multiple data objects are combined according to different sizes, positions, etc., to generate a combined image of a designated size, so that the combined image so generated can meet a requirement of a display size.

In implementations, the data object may be obtained from searches in multiple merchant stores.

In existing technologies, if a merchant wants to conduct publishing of a combination of article information, a designer is generally needed to produce a combined image, and the combined image is limited to commodities of that merchant. This type of method is not suitable for a merchant that sells articles of a single category. In the embodiments of the present application, articles are determined by a server, and the server can perform automatic searches across stores, which not only reduces labor costs, but also expands the range of combination of articles.

To facilitate implementations of the present application, commodity promotion in Taobao™ website is used as an example hereinafter for illustration.

At present, merchants in Taobao™ website may select some hot-sale commodities for promotion on pages of Taobao™ website. During promotion of single commodities, a merchant may set some commodity descriptive terms for each commodity respectively, such as “Chinese Valentine's Day present for girlfriend, creative heart-shaped silver necklace”, to facilitate searches by common consumers. A commodity prompted in an advertising space is merely a hot-sale single commodity set by each merchant, and this promotion approach of a single commodity does not achieve a desired promotion effect.

Therefore, the embodiments of the present application propose to combine hot-sale commodities of merchants, to provide a technical scheme of matching commodities for a common consumer as an advertisement for promotion, thus improving a promotional effect and promoting the success of commodity transaction.

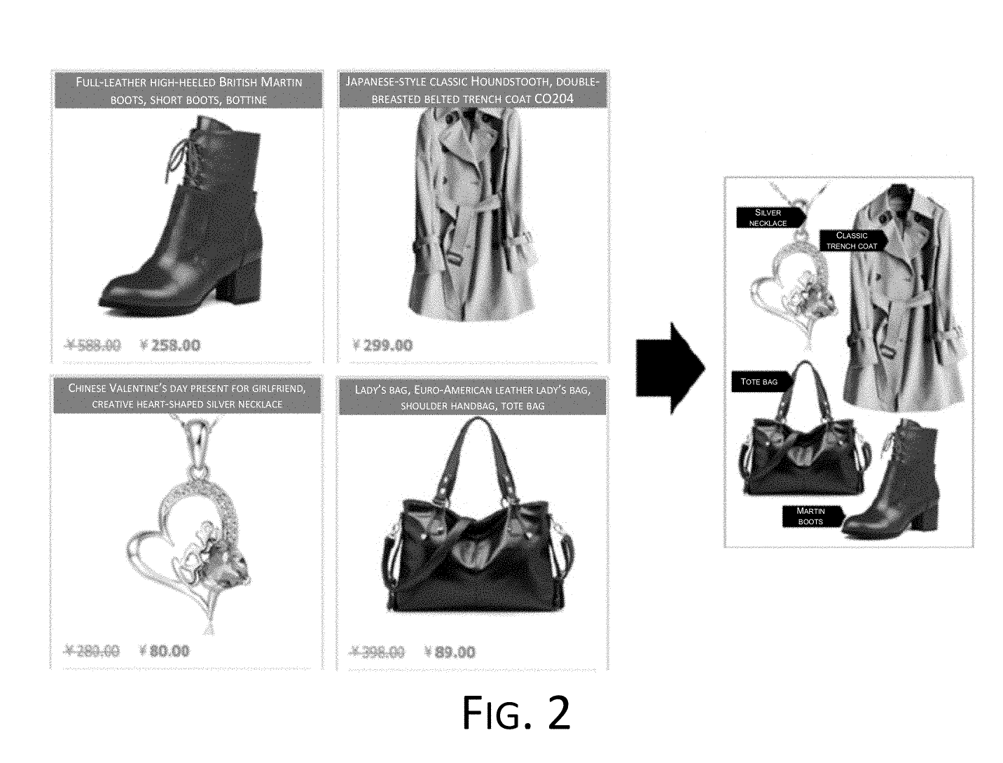

When a common consumer inputs information such as “Korean-style clothes for girlfriend” in a search field at the Taobao™ website, the embodiments of the present application may extract a keyword, such as “Korean-style”, from the information of “Korean-style clothes for girlfriend”. Then, from hot-sale commodity promotion (for example, a “quality product base” that is created on the website in advance), clothes, accessories, shoes, bags, etc., that have the style as “Korean-style” are searched from among stores according to single commodity descriptive terms set by merchants and respective categories to which commodities belong, to determine images of single commodities meeting the preset style in these four categories of clothes, accessories, shoes, and bags. For example, images of four single commodities are shown at the left side of FIG. 2.

Moreover, a keyword corresponding to each single commodity may be determined for an image of the respective commodity. For example, a keyword for a commodity “Chinese Valentine's Day present for girlfriend, creative heart-shaped silver necklace” may be set as “silver necklace”.

The images of the four single commodities are cut out using a cutout algorithm such as Bayes. Respective white backgrounds are deleted from the images of the single commodities having the white backgrounds, and single-commodity images are obtained by cutout. The four single-commodity images are matched according to feature values such as colors, textures and shapes, and then combined into an image displaying a solution of such matching. The combined image may be a combined image having a size of an advertising-space that is generated by shrinking/magnifying the single-commodity images to different sizes according to certain scales and combining thereof according to different arrangement layouts.

In the embodiments of the present application, an arrangement layout of each single-commodity image may be converted into coordinates of the respective single-commodity image in the combined image. A keyword of each single commodity is labeled as a page element into the coordinates of the respective single-commodity image, i.e., a position of the corresponding single commodity, through a CSS absolute positioning method. A URL address of a single commodity is located at a position of a respective keyword element using map and area attributes of an img label, and each commodity in the combined image is labeled automatically, a label thereof being linked to a detail page of the commodity, thereby implementing the objective of automatic labeling.

A combined image may include respective coordinates, keywords, URL addresses, names, and/or source paths of single-commodity images, sources of the combined image, etc.

Finally, an advertisement image (that is, the combined image that is generated) that is labeled with detail page links is pushed to the common consumer, and is displayed in an advertising space at the right side or bottom of the Taobao™ page of the common consumer, to provide a matching solution for the common consumer. FIG. 2 shows a schematic diagram using clothes, accessories, shoes and bags as examples, and an advertising image presented by a browser page to the user may be like the image as shown at the right side of FIG. 2.

By automatically matching, cutting out and combining images across stores, and automatically labeling commodity links for the hottest clothing-category commodities in the current e-commerce industry, the embodiments of the present application achieve an efficient promotion of clothing commodities, thereby solving the problem of automatic combination and promotion of commodities on a PC terminal and a mobile terminal, and at the same time, saving a large amount of manual design and operating costs.

Based on the same inventive ideas, the embodiments of the present application further provide an information publishing apparatus. As the problem-solving principles of these devices are similar to those of an information publishing method, implementations of these devices may be performed with reference to the implementation of the method, and same portions are not repeatedly described herein.

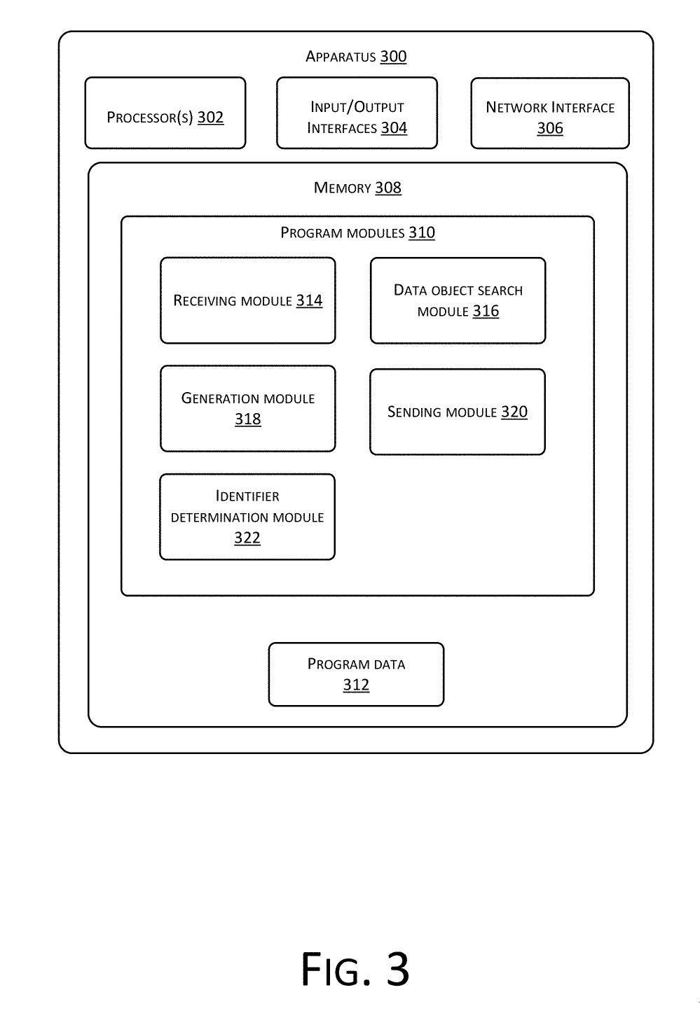

FIG. 3 is a schematic structural diagram of an information publishing apparatus according to the embodiments of the present application. In implementations, the information publishing apparatus 300 may include a computing device, or may be a portion of a computing device. By way of example and not limitations, the information publishing apparatus 300 may include one or more processors 302, an input/output interface 304, a network interface 306, and memory 308.

The memory 308 may include a form of computer readable media such as a volatile memory, a random access memory (RAM) and/or a non-volatile memory, for example, a read-only memory (ROM) or a flash RAM. The memory 308 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 308 may include program modules 310 and program data 312. The program modules 510 may include a receiving module 314 configured to receive input information of a user; a data object search module 316 configured to extract one or more keywords from the input information of the user, and perform a search based on the one or more keywords to obtain at least two data objects, each data object including at least one picture; a generation module 318 configured to extract at least partial images from respective pictures of the at least two data objects, and generate a combined image according to the at least partial images that are extracted; and a sending module 320 configured to send the combined image to the user.

In implementations, the generation module 318 may be specifically configured to generate the combined image based on the at least partial images that are extracted and respective link information of each data object.

In implementations, the data object search module 316 may be specifically configured to search different categories to obtain the at least two data objects.

In implementations, the information publishing apparatus may further include an identifier determination module 322 configured to determine an identifier of each data object after performing the search based on the one or more keywords to obtain the at least two data objects. The generation module 318 may be further configured to generate the combined image based on the at least partial images that are extracted and the identifier of each data object.

In implementations, the generation module 318 may be specifically configured to combine the partial images of the data objects according to different sizes and/or positions to generate a combined image of a designated size.

In implementations, the data object search module 316 may be specifically configured to conduct the search in stores of multiple merchants to obtain the at least two data objects.

For the sake of description, components of the apparatus are divided into different types of modules or units based on functionalities for individual descriptions. Apparently, when the present application is implemented, functions of the modules or units may be implemented in one or more pieces of software components and/or hardware components.

One skilled in the art should understand that the embodiments of the present application may be provided as a method, an apparatus, or a computer program product. Therefore, the present application may be implemented in the form of a complete hardware embodiment, a complete software embodiment, or an embodiment that is a combination of software and hardware. Moreover, the present application may employ a form of a computer program product implemented on one or more computer usable storage media (including, but not limited to, a magnetic disk memory, a CD-ROM, an optical memory, and the like) including computer usable program code.

The present disclosure is described with reference to flowcharts and/or block diagrams of the methods, devices (systems), and computer program products according to the embodiments of the present disclosure. It should be understood that computer program instructions may be used to implement each process and/or block in the flowcharts and/or block diagrams and a combination of process(es) and/or block(s) in the flowcharts and/or the block diagrams. These computer program instructions may be provided to a general-purpose computer, a special-purpose computer, an embedded processor, or a processor of another programmable data processing device to generate a machine, so that the instructions executed by a computer or a processor of another programmable data processing device generate an apparatus for implementing function(s) specified in one or more processes in the flowcharts and/or in one or more blocks in the block diagrams.

These computer program instructions may also be stored in a computer readable storage device that can instruct a computer or another programmable data processing device to perform operations in a particular manner, such that the instructions stored in the computer readable storage device generate an article of manufacture that includes an instruction apparatus. The instruction apparatus implements function(s) that is/are specified in one or more processes in the flowcharts and/or in one or more blocks in the block diagrams.

These computer program instructions may also be loaded onto a computer or another programmable data processing device, such that a series of operations are performed on the computer or the other programmable device, thereby generating computer-implemented processing. Therefore, the instructions executed on the computer or the other programmable device provide a procedure for implementing function(s) specified in one or more processes in the flowcharts and/or in one or more blocks in the block diagrams.

Although exemplry embodiments of the present application have been described, one skilled in the art may make other changes and modifications to these embodiments once knowing the basic inventive concept. Therefore, the appended claims are intended to be interpreted as including the exemplary embodiments and all changes and modifications that fall in the scope of the present application.

1. A method, comprising:
receiving input information of a user;
extracting one or more keywords from the input information of the user;
performing a search based on the one or more keywords to obtain at least two data objects, each data object comprising at least one picture;
extracting at least partial images from respective pictures of the at least two data objects;
generating a combined image based on the at least partial images; and
sending the combined image for presentation to the user.

2. The method of claim 1, wherein the combined image further comprises link information of each data object.

3. The method of claim 1, wherein the data objects are obtained by performing the search in different categories.

4. The method of claim 1, wherein after performing the search based on the one or more keywords to obtain the at least two data objects, the method further comprises determining an identifier of each data object, the combined image further comprising the identifier of each data object.

5. The method of claim 1, wherein generating the combined image based on the at least partial images comprises:
combining the partial images of the data objects according to different sizes and/or positions to generate a combined image of a designated size.

6. The method of claim 1, wherein the data objects are obtained by performing the search in stores of multiple merchants.

7. An information publishing apparatus, comprising:
a receiving module configured to receive input information of a user;
a data object search module configured to extract one or more keywords from the input information of the user, and perform a search based on the one or more keywords to obtain at least two data objects, each data object comprising at least one picture;
a generation module configured to extract at least partial images from respective pictures of the at least two data objects, and generate a combined image based on the at least partial images that are extracted; and
a sending module configured to send the combined image to the user.

8. The apparatus of claim 7, wherein the generation module is configured to generate the combined image based on the at least partial images that are extracted and link information of each data object.

9. The apparatus of claim 7, wherein the data object search module is configured to search in different categories to obtain the at least two data objects.

10. The apparatus of claim 7, further comprising an identifier determination module configured to determine an identifier of each data object after the search is performed abased on the one or more keywords to obtain at least two data objects, the generation module being further configured to generate the combined image based on the at least partial images that are extracted and the identifier of each data object.

11. The apparatus of claim 7, wherein the generation module is configured to combine the partial images of the data objects according to different sizes and/or positions to generate a combined image of a designated size.

12. The apparatus of claim 7, wherein the data object search module is configured to perform the search in stores of multiple merchants to obtain the at least two data objects.

13. The apparatus of claim 7, wherein the data object search module performs the search based on the one or more keywords by establishing a weight model using the one or more keywords as an input set and performing a semantic search using the weight model to obtain the at least two data objects.

14. One or more computer-readable media storing executable instructions that, when executed by one or more processors, to cause the one or more processors to perform acts comprising:
receiving input information of a user;
extracting one or more keywords from the input information of the user;
performing a search based on the one or more keywords to obtain at least two data objects, each data object comprising at least one picture;
extracting at least partial images from respective pictures of the at least two data objects;
generating a combined image based on the at least partial images; and
sending the combined image for presentation to the user.

15. The one or more computer-readable media of claim 14, wherein the combined image further comprises link information of each data object.

16. The one or more computer-readable media of claim 14, wherein the data objects are obtained by performing the search in different categories.

17. The one or more computer-readable media of claim 14, wherein after performing the search based on the one or more keywords to obtain the at least two data objects, the acts further comprise determining an identifier of each data object, wherein the combined image further comprises the identifier of each data object.

18. The one or more computer-readable media of claim 14, wherein generating the combined image based on the at least partial images comprises:
combining the partial images of the data objects according to different sizes and/or positions to generate a combined image of a designated size.

19. The one or more computer-readable media of claim 14, wherein the data objects are obtained by performing the search in stores of multiple merchants.

20. The one or more computer-readable media of claim 14, wherein performing the search based on the one or more keywords comprises establishing a weight model using the one or more keywords as an input set and performing a semantic search using the weight model to obtain the at least two data objects.
